(19) United States
(12) Patent Application Publication
(10) Pub. No.: US 2018/0229696 A1
(43) Pub. Date: Aug. 16, 2018

(54) JACK AND DOLLY ASSEMBLY AND METHOD OF OPERATION

(71) Applicant: Turbo Tech LLC, City of Industry, CA (US)

(72) Inventors: Ted Chen, Sierra Madre, CA (US); Tri Tran, Santa Ana, CA (US)

(21) Appl. No.: 15/429,562

(22) Filed: Feb. 10, 2017

(51) Int. Cl. B60S 9/215; B60D 1/66; B60S 9/16

(52) U.S. Cl. CPC B60S 9/215; B60S 9/16; B60D 1/665

(57) ABSTRACT

A jack and dolly assembly provides power-assisted lifting and moving capabilities using a single power source, according to an embodiment. In some embodiments a first shaft is used for lifting and lowering an object, and a second shaft is used for causing the jack and dolly assembly to move on a generally horizontal surface. In some embodiments the first and second shafts may selectively move or rotate independently from one another while being powered by the single power source. In some embodiments an inner and outer shaft arrangement is provided, so that the outer shaft has a hollow interior and at least a portion of the inner shaft is positioned within the hollow interior.

### 1. FIELD OF INVENTION

This generally relates to jack and dolly assemblies, and methods of operating them.

### 2. BACKGROUND

Jack mechanisms are mechanical devices used to lift heavy loads or otherwise apply strong, generally linear forces to objects. One use for jack mechanisms is with trailers such as, for example, boat trailers, camper trailers, house trailers, etc., that can be attached to and towed by vehicles. Trailer jack mechanisms often are attached to frames of trailers at a location close to a trailer coupler. Such jack mechanisms can be used for example to apply an upward force on trailers for static support upon the ground or other surface when the trailers are parked and disconnected from their towing vehicle, and to lower the trailers (or to reduce the upward force) for connecting them to their towing vehicle, for example.

A dolly can refer to a mechanism that includes a platform or frame which in turn is disposed on one or more wheels for use in holding and moving heavy loads. One application for a dolly is for use with trailers such as, for example, boat trailers, camper trailers, house trailers, etc., that can be attached to and towed by vehicles. When used for some trailers, a dolly can assist in moving them for short distances, such as to facilitate attaching to trailer couplers or connection members of towing vehicles. A dolly also can be used for parking or positioning trailers when they are not attached to towing vehicles. Trailer dollies can be power-assisted, or they can be manual without any electrical or mechanical power source. The wheels for power-assisted dollies can be driven by electric or gas motors, or driven by manually-actuated mechanisms, such as hand cranks and associated gear assemblies, which provide mechanical advantages or leverages, for example.

### SUMMARY OF CERTAIN EMBODIMENTS

Broadly speaking, certain embodiments of the invention relate to a combined jack and dolly assembly that may provide power-assisted lifting and traveling capabilities using a single power source. The use of a single power source for both capabilities may be advantageous over alternative assemblies in that a reduction in weight, size and manufacturing costs may be realized.

In a first embodiment, a brake mechanism of a jack and dolly assembly is placed in a first state. The first state is one of engagement with a first shaft to prevent rotation of the first shaft and non-engagement with a second shaft. At least one wheel of the jack and dolly assembly is extended or retracted by operating a driving unit to rotate the second shaft during a time that the brake mechanism is in the first state and that the first shaft is not rotating. The brake mechanism is placed in a second state. The second state is one of engagement with the second shaft to prevent rotation of the second shaft and non-engagement with the first shaft. The at least one wheel of the jack and dolly assembly is rotated by operating the driving unit to rotate the first shaft during a time that the brake mechanism is in the second state and that the second shaft is not rotating.

In a second embodiment, a jack and dolly assembly comprises at least one wheel, a first shaft, a second shaft, and a brake mechanism having a first state and a second state. The first state is one of engagement with the first shaft and non-engagement with the second shaft. The second state is one of engagement with the second shaft and non-engagement with the first shaft. The jack and dolly assembly further includes means for rotating the first shaft during a time that the second shaft is not rotating and that the brake mechanism is in the first state, and for rotating the second shaft during a time that the first shaft is not rotating and that the brake mechanism is in the second state. The jack and dolly assembly further includes means for extending and retracting the at least one wheel in response to the rotation of the first shaft, and includes means for rotating the at least one wheel in response to the rotation of the second shaft.

In a third embodiment, a jack and dolly assembly comprises a driving unit, at least one wheel, and a differential gear assembly configured to receive a driving force from the driving unit and to generate at least two outputs. A first shaft is coupled to a first one of the at least two outputs for rotation of the first shaft. A second shaft is coupled to a second one of the at least two outputs for rotation of the second shaft. The differential gear assembly is further configured to rotate the first shaft during a time that external resistance is applied to the second shaft and to rotate the second shaft during a time that external resistance is applied to the first shaft. A brake mechanism has a state of engagement or non-engagement with each of the first shaft and the second shaft to selectively interrupt the rotation of one of the first and second shafts during the time that the differential gear assembly is receiving the driving force. The one of the first and second shafts comprises a lead screw for use in translating rotation of the lead screw into a generally linear motion for extending or retracting the at least one wheel. The other of the first and second shafts comprises at least a portion of a drive train for rotating the at least one wheel.

In a fourth embodiment, a jack and dolly assembly comprises an outer shaft defining a longitudinal axis extending through the outer shaft and further defining an interior hollow extending along the longitudinal axis. An inner shaft is at least partially positioned within the interior hollow of the outer shaft. A gear assembly is operatively coupled to the outer and inner shafts to rotate the outer shaft in response to a driving force received by the gear assembly during a time that external resistance is applied to the inner shaft, and to rotate the inner shaft in response to the driving force received by the gear assembly during a time that external resistance is applied to the outer shaft.

The jack and dolly assembly of the fourth embodiment further includes a brake mechanism having a state of engagement or non-engagement with each of the outer shaft and the inner shaft to selectively interrupt the rotation of one of the inner and outer shafts while not interrupting the rotation of the other of the inner and outer shafts during a time that the gear assembly is receiving the driving force. A wheel assembly comprises at least one wheel, wherein the at least one wheel is rotatively coupled to a first one of the inner shaft and the outer shaft. A threaded member is engaged with a second one of the inner shaft and the outer shaft. The first one of the inner shaft and the outer shaft is coupled to the at least one wheel to impart a driving rotation to the at least one wheel in response to the rotation of the first one of the inner shaft and the outer shaft. The second one of the inner shaft and the outer shaft has threads which engage the threaded member. The wheel assembly is coupled with the threaded member so that rotation of the second one of the inner shaft and the outer shaft causes a generally linear translation of the wheel assembly.

In a fifth embodiment, a jack and dolly assembly comprises a driving unit and an outer shaft defining a longitudinal axis extending through the outer shaft and further defining an interior hollow extending along the longitudinal axis. An inner shaft is at least partially positioned longitudinally within the interior hollow of the outer shaft. A ring gear has a ring gear axis and is coupled to the driving unit. The ring gear is configured to rotate about the ring gear axis in response to a driving force from the driving unit. A driving gear is coupled to the ring gear and has a driving gear axis substantially transverse to the ring gear axis. The driving gear is configured to rotate around the driving gear axis and is further configured to be carried around the ring gear axis in response to a rotation of the ring gear.

The jack and dolly assembly of the fifth embodiment further comprises a first driven gear and a second driven gear. Each of the first and second driven gears is engaged with the driving gear and is configured to rotate about the ring gear axis in response to movement of the driving gear around the ring gear axis. The first driven gear is connected to the outer shaft and configured to rotate the outer shaft. The second driven gear is connected to the inner shaft and configured to rotate the inner shaft.

The jack and dolly assembly of the fifth embodiment further comprises a brake mechanism having a first brake position and a second brake position. During a time that the brake mechanism is in the first brake position, the brake mechanism is configured to prevent rotation of the first driven gear and the outer shaft while the second driven gear and the inner shaft are rotating in response to the rotation of the driving gear. During a time that the brake mechanism is in the second brake position, the brake mechanism is configured to prevent rotation of the second driven gear and the inner shaft while the first driven gear and the outer shaft are rotating in response to the rotation of the driving gear.

The jack and dolly mechanism of the fifth embodiment further includes a wheel assembly comprising at least one wheel. The wheel assembly is threadedly coupled to one of the outer shaft and the inner shaft. The at least one wheel is rotatively coupled to the other one of the outer shaft and the inner shaft. The wheel assembly is configured to move in a generally linear direction along or parallel to the longitudinal axis of the outer shaft in response to the rotation of the one of the outer and inner shafts. The at least one wheel is configured to rotate in response to the rotation of the other one of the outer and inner shafts.

There are additional aspects to the present inventions. It should therefore be understood that the preceding is merely a brief summary of some embodiments and aspects of the present inventions. Additional embodiments and aspects are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIG. 1A is a perspective view of a jack and dolly assembly attached to a trailer according to one embodiment;

FIG. 1B is a perspective view of a jack and dolly assembly attached to a trailer according to another embodiment;

FIG. 2 is a perspective view of certain components of a jack and dolly assembly which are separated from one another, according to an embodiment;

FIG. 3 is an exploded parts diagram illustrating an inner shaft and an outer shaft, as well as certain components of an upper assembly portion of a jack and dolly assembly according to an embodiment;

FIGS. 4A and 4B are exploded parts diagrams illustrating an inner shaft as well as certain components of a lower assembly portion of the jack and dolly assembly of FIG. 3;

FIG. 5 is a simplified diagram of certain components of a jack and dolly assembly which may be used to selectively transfer power from a single power source to one or the other of two shafts, according to an embodiment;

FIG. 6A is a plan view of a gear mechanism and portions of the two shafts of the embodiment of FIG. 5;

FIG. 6B is an exploded parts diagram of certain components of the gear mechanism of FIG. 6A;

FIG. 6C is another exploded parts diagram of certain components of the gear mechanism of FIG. 6B, but with the components arranged in a different fashion and with certain components removed;

FIG. 7 is a simplified diagram of certain components of the lower assembly portion of the jack and dolly mechanism of FIGS. 4A and 4B; and

FIG. 8 is a simplified drawing of certain of the components of the lower assembly portion of FIG. 7 with certain other components removed for clarity of illustration.

### DETAILED DESCRIPTION

The following description is of the best mode presently contemplated for carrying out claimed subject matter. Moreover in the following description, details are set forth by way of example to enable a person of ordinary skill in the art to practice claimed subject matter without undue experimentation. Reference will be made in detail to embodiments of claimed subject matter, examples of which are illustrated in the accompanying drawings, wherein like reference numerals refer to like elements throughout. It is understood that other embodiments may be used and structural and operational changes may be made without departing from the scope of claimed subject matter.

As previously mentioned, embodiments of the invention may include a combined jack and dolly assembly that may provide power-assisted lifting and traveling capabilities using a single power source. The use of a single power source for both capabilities may be advantageous over alternative assemblies in that a reduction in weight, size and manufacturing costs may be realized. In some embodiments a first shaft may be used for lifting an object and a second shaft may be used for moving the jack and dolly assembly over the ground or other surface with or without carrying an object. In some embodiments the first and second shafts may move or rotate independently from one another while being powered by the single power source. In some embodiments an inner and outer shaft arrangement is provided, wherein the outer shaft may have a hollow interior extending longitudinally through the outer shaft, and wherein at least a portion of the inner shaft may be positioned longitudinally within the hollow interior of the outer shaft. Advantageously this inner and outer shaft arrangement may save space and reduce the overall size of the jack and dolly assembly.

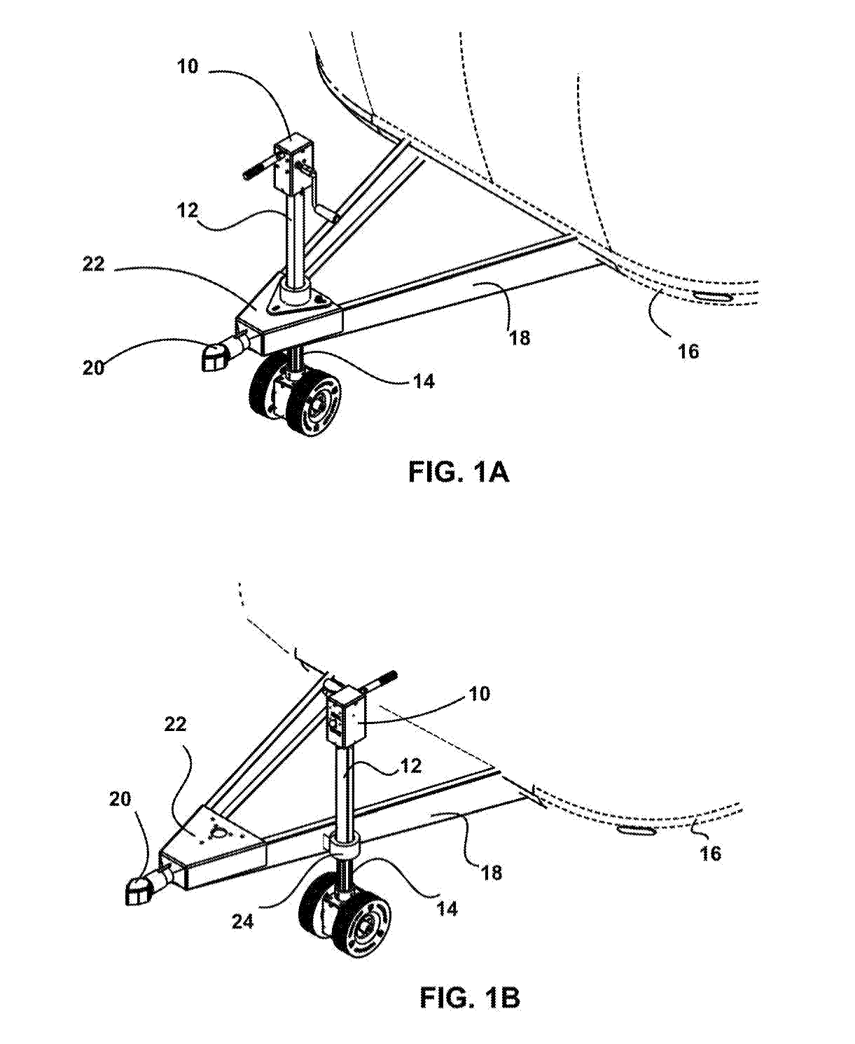

FIGS. 1A and 1B are perspective views of a jack and dolly assembly 10 attached to a trailer frame 18 of a trailer 16, such as one that may be attached to a motor vehicle for towing a boat, a camper, etc., according to various embodiments. Jack and dolly assembly 10 may include an upper assembly portion 12 and a lower assembly portion 14. In FIG. 1A, jack and dolly assembly 10 may be connected proximate to a coupler 20 of trailer frame 18 by attachment to a coupler tongue 22 of trailer frame 18 of trailer 16. In FIG. 1B an alternative attachment is illustrated wherein jack and dolly assembly 10 may be attached to trailer frame 18 via a side mounting bracket 24. As explained in more detail elsewhere herein, lower assembly portion 14 may be retracted or raised upwardly so that its wheels may no longer touch the ground or other surface. Also lower assembly portion 14 may be extended downwardly so that its wheels may touch and exert pressure against the ground or other surface. This in turn may permit jack and dolly assembly 10 to apply an upward force upon trailer frame 18 for static support, etc. While FIGS. 1A and 1B illustrate jack and dolly assembly embodiments that may be used in connection with trailers, alternative embodiments are not so limited. Rather, embodiments may be used for other applications where a mechanism may be desired to apply a generally linear force to objects such as for lifting, spreading, etc., while the mechanism does not move along the ground or other surface and/or where it may be desired to use the mechanism to move itself, with or without other objects, along the ground or other surface via one or more power-assisted wheels.

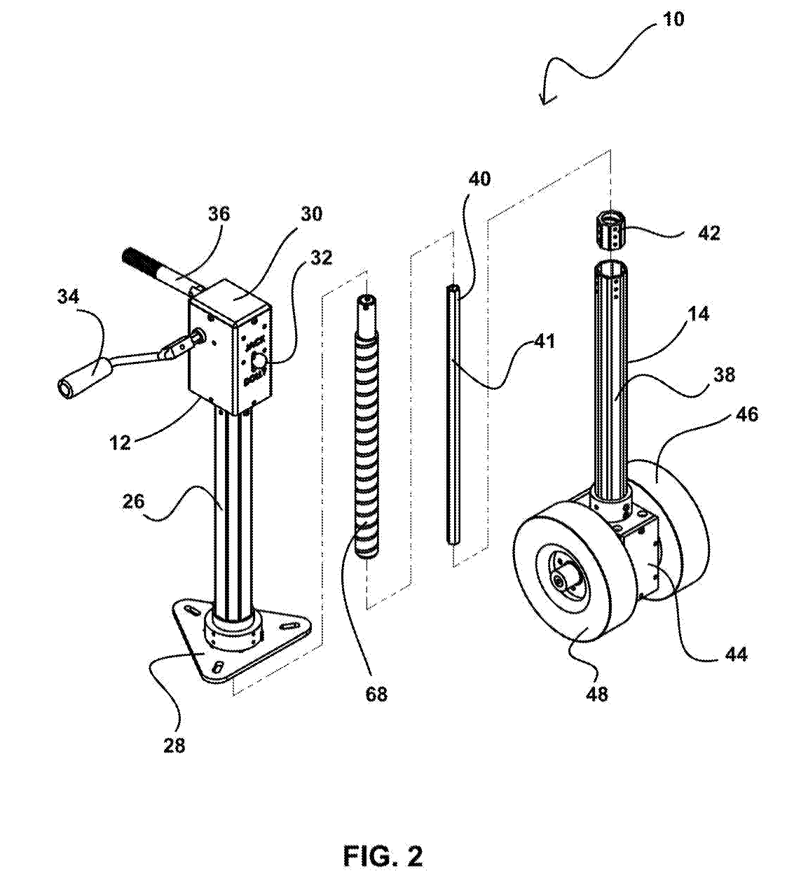

FIG. 2 is a perspective view of certain components of jack and dolly assembly 10, wherein these components are disassembled or separated from one another for clarity of illustration. Upper assembly portion 12 may be comprised of trailer adapter mounting plate 28, upper assembly shaft housing 26, upper assembly outer housing 30, function switch actuator 32, steering handle 36 and power input handle 34. Lower assembly portion 14 may be comprised of first wheel 46, second wheel 48, lower assembly housing 44, lower assembly shaft housing 38, and threaded member 42. Jack and dolly assembly 10 further includes a first or outer shaft 68 and a second or inner shaft 40. Inner shaft 40 may comprise an inner shaft outer member 41 and an inner shaft inner member (not shown in FIG. 2). In an embodiment threaded member 42 may have a generally hollow interior extending longitudinally throughout and may comprise a plurality of internal threads which may engage with external threads of outer shaft 68. In an embodiment, threaded member 42 may comprise a nut. In an embodiment outer shaft 68 may have a hollow interior extending longitudinally through the shaft. When assembled at least a portion of inner shaft 40 may be disposed or positioned longitudinally within the hollow interior of outer shaft 68, and at least a portion of outer shaft 68 may be disposed within upper assembly shaft housing 26. Also when assembled inner shaft 40 may be positioned within lower assembly shaft housing 38, and also may extend into upper assembly shaft housing 26 (while also being disposed with the hollow interior of outer shaft 68) and terminate in upper assembly outer housing 30, as described in more detail elsewhere herein.

Trailer adapter mounting plate 28 may be used to connect jack and dolly assembly 10 to an external object being handled, such as coupler tongue 22 of trailer frame 18 of FIG. 1A, for example. Upper assembly shaft housing 26 may be operatively coupled to lower assembly portion 14 so that upper assembly shaft housing 26 and lower assembly portion 14 both may rotate clockwise and counterclockwise around a longitudinal axis of jack and dolly assembly 10 in response to a rotary movement of steering handle 36 by a user when it is desired to steer jack and dolly assembly 10 during movement when first and second wheels 46, 48 are touching the ground or other surface and bearing some load, or to rotate first and second wheels 46, 48 and lower assembly housing 44 when the wheels are retracted and not touching the ground or other surface.

Upper assembly outer housing 30 may be attached to upper assembly shaft housing 26 and enclose one or more gears (not shown in FIG. 2) as explained in more detail elsewhere herein. Power input handle 34 may be operatively coupled to inner shaft 40 and outer shaft 68 in order to manually and selectively rotate each shaft with a mechanical power assist via a leverage or mechanical advantage provided by linkages and/or gears (not shown in FIG. 2). In alternative embodiments, power input handle 34 may be replaced or supplemented by a motor which may include an electric motor such as, for example, a hand drill motor, or a gas powered motor. In an embodiment power input handle 34 or a motor may rotate in a first direction and a second direction, e.g., rotate in a clockwise and a counterclockwise direction, which in turn may cause inner shaft 40 or outer shaft 68 to rotate in a first direction and a second direction, e.g., rotate in a clockwise and a counterclockwise direction.

In operation, function switch actuator 32 may be placed in one of two positions depending upon whether the user desires to use a first function wherein the jack and dolly assembly 10 may be extended or retracted for axially removing or exerting a force or pressure on a load, or whether the user desires to use a second function wherein the jack and dolly assembly 10 may be moved along a generally horizontal surface (such as the ground or other surface, for example) by applying a rotational force to first and second wheels 46, 48, so that they rotate about a wheel axis which may be generally perpendicular to the longitudinal axis of jack and dolly assembly 10, according to the illustrated embodiment.

Threaded member 42 may be fixedly attached to lower assembly shaft housing 38 and may be threadedly engaged with outer shaft 68. Thus when outer shaft 68 rotates in response to a movement of power input handle 34, threaded member 42 and lower assembly portion 14 may be translated generally linearly so that lower assembly portion 14 may extend or retract along the longitudinal axis of outer shaft 68 and of jack and dolly assembly 10 in the illustrated embodiment, depending upon the clockwise or counterclockwise direction of rotation of outer shaft 68. In an embodiment outer shaft 68 and threaded member 42 comprise a traveling-nut linear actuator. Lower assembly shaft housing 38 may be sized to fit within upper assembly shaft housing 26 to allow for a generally linear movement (e.g., retraction or extension) within and relative to it. Also inner shaft 40 may be telescoping or retractable to allow for increases and decreases in its length in response to an axial movement of lower assembly portion 14. In an embodiment lower assembly portion 14 assembly may be threadedly coupled with outer shaft 68 for a generally linear movement of lower assembly portion 14 in a direction along the longitudinal axis of outer shaft 68 in response to a rotation of outer shaft 68.

When inner shaft 40 is caused to rotate around its longitudinal axis in a clockwise or counterclockwise direction by power input handle 34, this rotational force may be translated to a force for rotating first and second wheels 46, 48 in a clockwise or counterclockwise direction through mechanical linkages in lower assembly housing 44 as described elsewhere herein. It can be appreciated therefore that inner shaft 40 may comprise a drive shaft and may be coupled to a wheel assembly comprising first and second wheels 46, 48 in order to impart a driving rotation to these wheels in response to a rotation of inner shaft 40. The wheel assembly may be coupled with threaded member 42 so that a rotation of outer shaft 68 may cause a generally linear translation of the wheel assembly. Referring to FIGS. 1A and 1B, for example, a generally linear translation of first and second wheels 46, 48 in an upward direction may cause them to lift off of the ground or other surface in view of jack and dolly assembly 10 being attached to trailer frame 18 of trailer 16. On the other hand, a generally linear translation of first and second wheels 46, 48 in a downward direction may cause them to push downward against the ground or other surface thereby providing a lifting or upward force against trailer frame 18 and trailer 16 in order to lift coupler 20 off of a vehicle trailer mount (not shown in FIG. 1) and/or to provide static support for trailer 16.

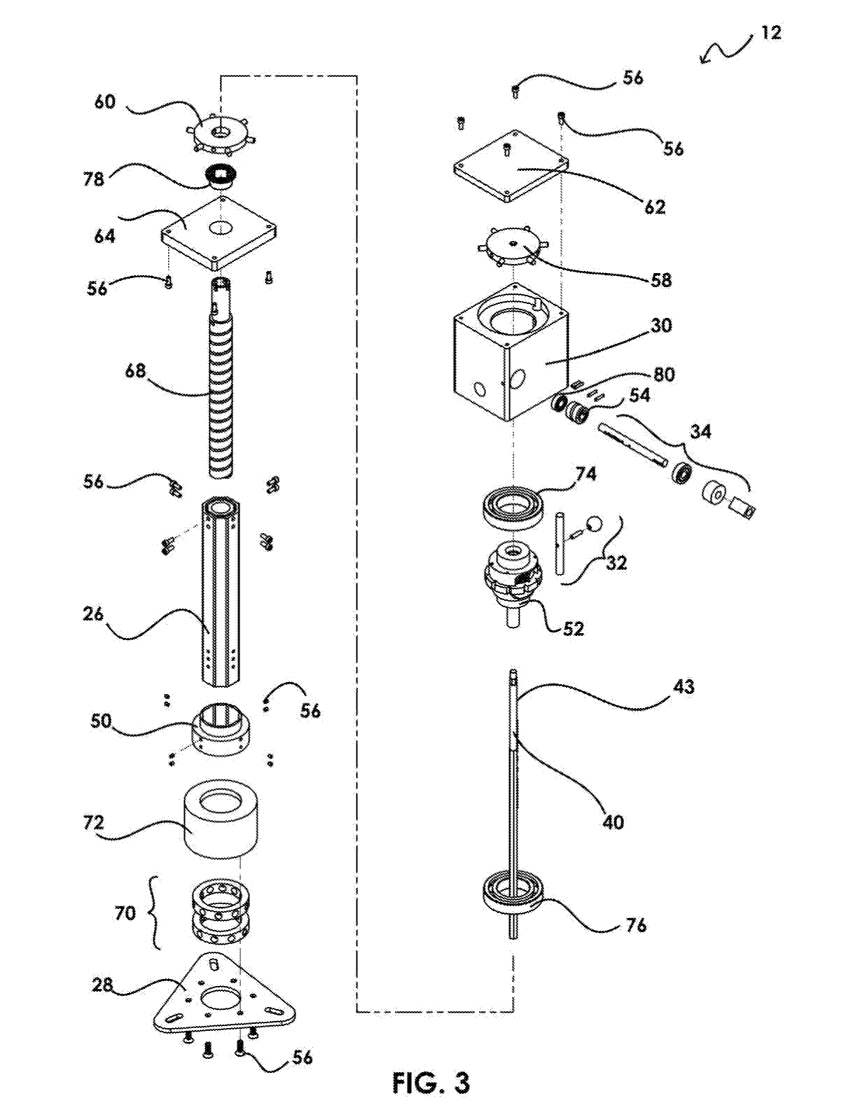

FIG. 3 is an exploded parts diagram illustrating inner shaft 40, outer shaft 68, as well as certain components of upper assembly portion 12 of jack and dolly assembly 10. Inner shaft 40 is comprised of inner shaft inner member 43 and inner shaft outer member 41 (FIG. 2). In the illustrated embodiment, inner shaft inner member 43 may be configured to fit longitudinally within inner shaft outer member 41, so that inner shaft 40 may be telescoping or retractable and have a variable length. In an embodiment each of inner shaft inner and outer members 43, 41 may have a matching polygonal-shaped cross section for a mating engagement with one another, and so that a rotation of inner shaft inner member 43 may impart a rotation upon inner shaft outer member 41.

Upper assembly portion 12 may be comprised of trailer adapter mounting plate 28, rotation bearing assembly 70, bearing housing 72, upper assembly shaft housing 26, shaft housing support 50, upper assembly outer housing 30, power input handle 34, brake mechanism lower contact member 60, brake mechanism upper contact member 58, function switch actuator 32, upper assembly gear mechanism 52, worm gear 54, housing upper cover plate 62, housing lower cover plate 64, first bearing 74, second bearing 76, third bearing 78, and fourth bearing 80. As previously mentioned outer shaft 68 may include threads for threaded engagement with threaded member 42 (FIG. 2). In an embodiment outer shaft 68 may comprise threads having an Acme thread form. In an embodiment outer shaft 68 may comprise a lead screw and threaded member 42 (FIG. 2) may comprise a lead nut. Outer shaft 68 may extend axially inside and through upper assembly shaft housing 26, and one end of outer shaft 68 may extend into upper assembly outer housing 30. Moreover the other end of outer shaft 68 may extend through shaft housing support 50, bearing housing 72, rotation bearing assembly 70 and trailer adapter mounting plate 28, so that outer shaft 68 may engage lower assembly shaft housing 38 via threaded engagement with threaded member 42 (FIG. 2). As previously mentioned, outer shaft 68 may define a longitudinal axis extending through outer shaft 68 and may further define an interior hollow extending along the longitudinal axis. Inner shaft 40 may be at least partially positioned longitudinally within the interior hollow of outer shaft 68.

As previously mentioned trailer adapter mounting plate 28 may be used to connect jack and dolly assembly 10 to an external object being handled, such as a trailer, for example. Shaft housing support 50 may be constructed to include a static portion and a rotational portion. Upper assembly shaft housing 26 may be seated within shaft housing support 50 and may be connected to its rotational portion with fasteners 56, such as screws, bolts, or rivets, for example. The static portion of shaft housing support 50 may be attached to trailer adapter mounting plate 28 with fasteners 56. Upper assembly shaft housing 26 may enclose outer shaft 68 as well as a portion of inner shaft 40, and is sized to slidingly receive lower assembly shaft housing 38 (FIG. 2). Rotation bearing assembly 70 may be disposed within bearing housing 72 which in turn may be disposed within shaft housing support 50 thus permitting the rotational portion of shaft housing support 50 to rotate around a longitudinal axis of upper assembly shaft housing 26. Accordingly this may allow a rotation of upper shaft housing 26 (as well as lower assembly portion 14 (FIG. 2)) when a user desires to steer jack and dolly assembly 10 by moving steering handle 36 (FIG. 2) which may be connected to upper assembly outer housing 30.

Upper assembly outer housing 30 may include housing lower cover plate 64 which may be attached to the upper end of upper assembly shaft housing 26. Upper assembly outer housing 30 may enclose various components, such as for example, upper assembly gear mechanism 52, worm gear 54, brake mechanism lower contact member 60, brake mechanism upper contact member 58, and a portion of function switch actuator 32, as well as certain bearings. Housing upper cover plate 62 may be fastened to upper assembly outer housing 30 with fasteners 56 for completing the enclosure.

Upper assembly gear mechanism 52 may receive an input torque transferred from power input handle 34 via worm gear 54. In response to the input torque from this single power source, upper assembly gear mechanism 52 may provide two rotational outputs, one for rotating outer shaft 68 in a clockwise or counterclockwise direction and the other output for rotating inner shaft 40 in a clockwise or counterclockwise direction. Brake mechanism lower contact member 60, brake mechanism upper contact member 58, and function switch actuator 32 may comprise a brake assembly having a state of engagement or non-engagement with each of inner shaft 40 and outer shaft 68 to selectively interrupt the rotation of either one of these two shafts while not interrupting the rotation of the other of these two shafts during the time that the upper assembly gear mechanism 52 receives the input torque or driving force. In response to receipt of a driving force or torque, upper gear assembly mechanism 52 may be operatively coupled to outer and inner shafts 68, 40 to rotate the outer shaft 68 in a clockwise or a counterclockwise direction during the time that external resistance is applied to inner shaft 40. Moreover in response to receipt of a driving force or torque, upper gear assembly mechanism 52 may further be operatively coupled to outer and inner shafts 68, 40 to rotate inner shaft 40 in a clockwise or a counterclockwise direction during the time that external resistance is applied to outer shaft 68. Operation of upper assembly gear mechanism 52 and the brake assembly is discussed in more detail elsewhere herein.

First bearing 74 and second bearing 76 may permit rotation of upper assembly gear mechanism 52 with respect to upper assembly outer housing 30. Third bearing 78 may facilitate rotation of outer shaft 68 with respect to housing lower cover plate 64. Fourth bearing 80 may facilitate rotation of power input handle 34 relative to upper assembly outer housing 30.

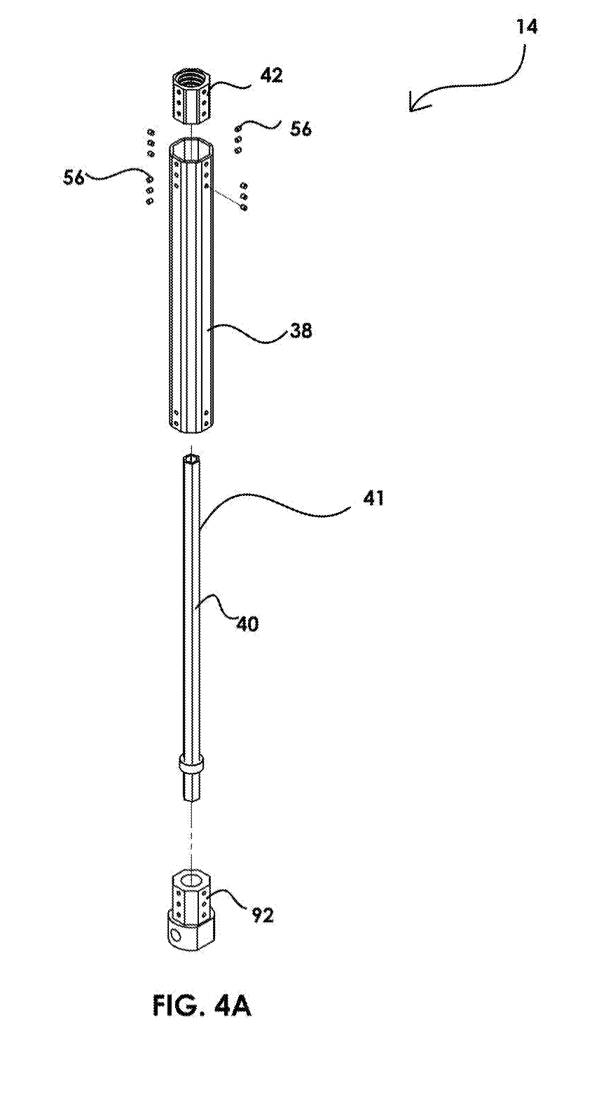

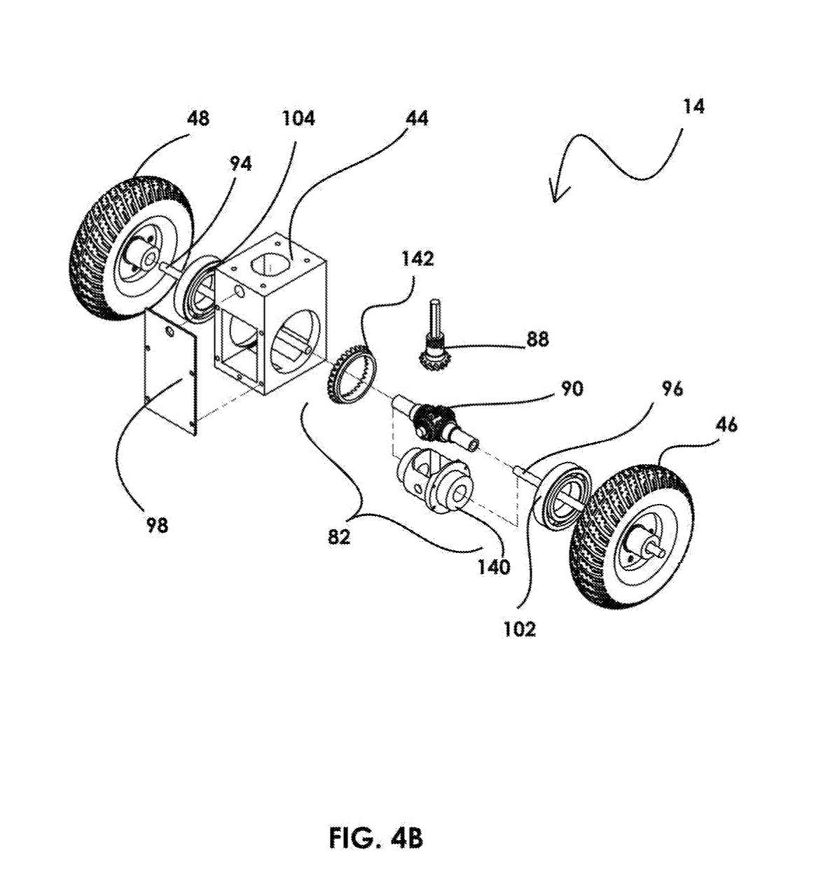

FIGS. 4A and 4B are exploded parts diagrams illustrating inner shaft 40 as well as certain components of lower assembly portion 14 of jack and dolly assembly 10. As mentioned elsewhere herein inner shaft 40 comprises inner shaft outer member 41 (FIG. 4A) and inner shaft inner member 43 (FIG. 3) so that inner shaft 40 may be telescoping and therefore extendable and retractable in order to follow the movement of lower assembly shaft housing 38 into and out of upper assembly shaft housing 26 (FIG. 3) as discussed elsewhere herein. Inner shaft 40 may extend axially inside and through lower assembly shaft housing 38 along its longitudinal axis. One end of inner shaft 40 (e.g., one end of inner shaft inner member 43) of may extend inside and through upper assembly shaft housing 26 and into upper assembly outer housing 30 (FIG. 3). The other end of inner shaft 40 (e.g., one end of inner shaft outer member 41) may extend to lower assembly housing 44, so that inner shaft 40 may be operatively coupled with first and second wheels 46, 48 to provide a torque to the wheels so that they may rotate in a clockwise or a counterclockwise direction. In an embodiment inner shaft 40 comprises at least a portion of a drive train for rotating the wheels. As previously mentioned, at least a portion of inner shaft 40 may be enclosed and may extend longitudinally within outer shaft 68 (FIG. 3).

Still referring to FIGS. 4A and 4B, lower assembly portion 14 may comprise threaded member 42, lower assembly shaft housing 38, lower assembly bottom adapter 92, torque transfer gear 88, lower assembly housing 44, cover plate 98, first wheel 46, first wheel axle 96, second wheel 48, second wheel axle 94, lower assembly gear mechanism 82, sixth bearing 102 and seventh bearing 104. Lower assembly gear mechanism 82 in turn may comprise second rotatable housing 140, second ring gear 142 and a plurality of lower assembly gears 90. Threaded member 42 may be fixedly attached to lower assembly shaft housing 38 at one end of the housing with fasteners 56, and lower assembly bottom adapter 92 may be fixedly attached to lower assembly shaft housing 38 at its other end. Lower assembly bottom adapter 92, in turn, may be attached to lower assembly housing 44, so that during the time that lower assembly shaft housing 38 is extending into or retracting from upper assembly shaft housing 26 (FIG. 3), lower assembly housing 44 may be carried along with lower assembly shaft housing 38. Also carried during this motion are torque transfer gear 88, first wheel 46, first wheel axle 96, second wheel 48, second wheel axle 94 and lower assembly gear mechanism 82, among other components.

Lower assembly bottom adapter 92 may be disconnected by a user from lower assembly housing 44 so that lower assembly housing 44, torque transfer gear 88, first wheel 46, first wheel axle 96, second wheel 48, second wheel axle 94 and lower assembly gear mechanism 82, among other components, are not carried by lower assembly shaft housing 38. The detachable feature of lower assembly bottom adapter 92 may provide a user with an option to perform a jacking operation by rotating outer shaft 68 (FIG. 2) which may result in extending inner shaft 40 and lower assembly bottom adapter 92 to the ground or other surface so that bottom adapter 92 may directly contact and exert a downward force directly on the ground or other surface. Alternatively a user also may optionally connect lower assembly bottom adapter 92 to lower assembly housing 44 and still perform a jacking operation by rotating outer shaft 68 (FIG. 2) in order to exert a downward force on lower assembly housing 44 which in turn may result in a downward force exerted on first and second wheels 46, 48 when they are in contact with the ground or other surface. The detachable feature of lower assembly bottom adapter 92 also may be advantageous by providing a greater clearance between the ground (or other surface) and jack and dolly mechanism 10 when a trailer is being towed by a vehicle. If lower assembly housing 44, torque transfer gear 88, first wheel 46, first wheel axle 96, second wheel 48, second wheel axle 94 and lower assembly gear mechanism 82 (among other components) are not detached during towing, then a clearance between bottom portions of first and second wheels 46, 48 and the ground may be less than would be the case if these components are detached during towing. A greater clearance between wheels and the ground may be desirable when towing over uneven roads or other surfaces.

One end of inner shaft 40 (e.g., one end of inner shaft outer member 41) may be attached to or seated within lower assembly bottom adapter 92, which in turn may be attached to torque transfer gear 88 so that it may rotate in a clockwise or counterclockwise direction in response to a clockwise or counterclockwise rotation of inner shaft 40. First and second wheels 46, 48 may be rotatively coupled to inner shaft 40, and accordingly inner shaft 40 may comprise a drive shaft. In the illustrated embodiment torque transfer gear 88 may be coupled to second ring gear 142 of lower assembly gear mechanism 82 so that torque associated with the rotation of inner shaft 40 may be transferred into a torque and rotation of first and second wheel axles 94, 96, which in turn may power a clockwise or counterclockwise rotation of first and second wheels 46, 48. Cover plate 98 may attach to lower assembly housing 44 in order to complete the enclosure and provide protection of the components housed therein. Sixth and seventh bearings 102, 104 may facilitate rotation of lower assembly gear mechanism 82 with respect to lower assembly housing 44.

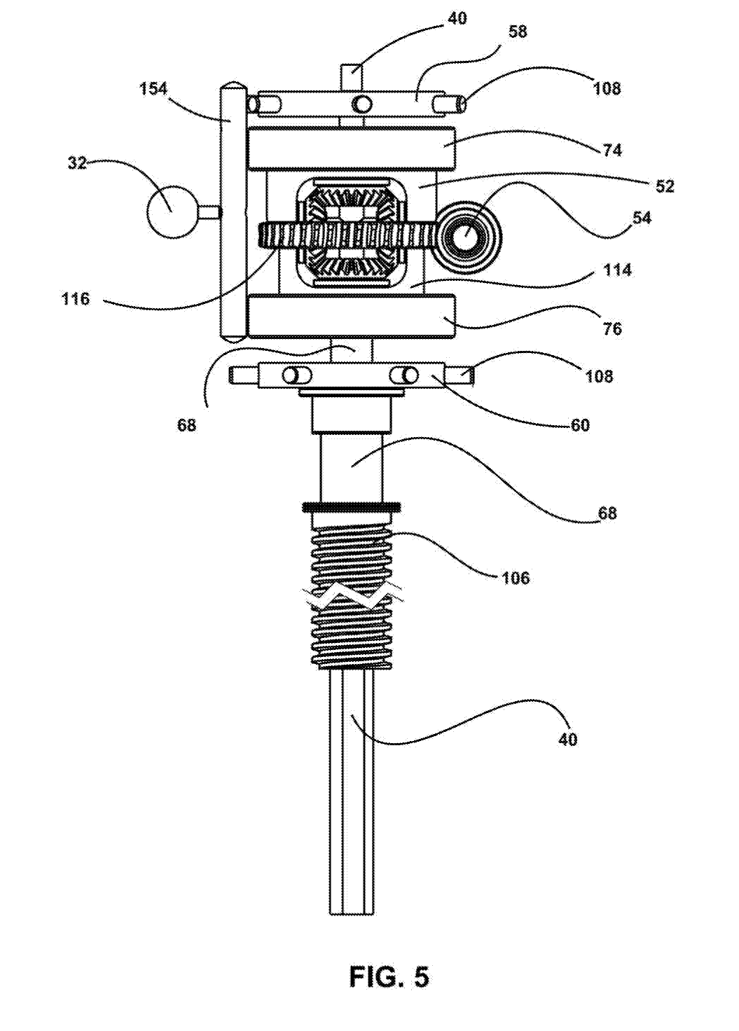

FIG. 5 is a simplified illustration of certain components of jack and dolly assembly 10 that may be used to selectively transfer power from a single power source such as, for example, power input handle 34 of FIG. 3, to rotate outer shaft 68 and inner shaft 40 in a clockwise and counterclockwise direction, according to an embodiment. Upper assembly gear mechanism 52 may include first ring gear 116 which mates with worm gear 54 which, in turn, may receive power from power input handle 34 (FIG. 3). Upper assembly gear mechanism 52 may further include a first rotatable housing 114 which rotates in response to a movement of first ring gear 116 as described in more detail elsewhere herein. First and second bearings 74, 76 may facilitate the rotation of first rotatable housing 114 within and relative to upper assembly outer housing 30 (FIG. 3). Outer shaft 68 may include a threaded portion 106 and may attach to a bottom or distal side of upper assembly gear mechanism 52 for being driven or rotated by it. At least a portion of inner shaft 40 may be disposed within outer shaft 68 and extend through an interior of upper assembly gear mechanism 52. A proximate end of inner shaft 40 may terminate at a relatively short distance beyond the proximate side of upper assembly gear mechanism 52. Inner shaft 40 may be fixedly attached to the upper or proximate side of upper assembly gear mechanism 52 for being driven or rotated by it.

Brake mechanism lower contact member 60, brake mechanism upper contact member 58, and function switch actuator 32 may comprise a brake assembly which may selectively interrupt the rotation of one of either the outer shaft 68 or inner shaft 40 during the time that the input torque or driving force is being received. Brake mechanism upper contact member 58 may be disposed proximate to the proximate side of upper assembly gear mechanism 52 and may be fixedly attached to inner shaft 40 so that brake mechanism upper contact member 58 may rotate around the longitudinal axis of inner shaft 40 along with a rotation of inner shaft 40. Brake mechanism lower contact member 60 may be disposed proximate to the distal side of upper assembly gear mechanism 52 and may be fixedly attached to outer shaft 68 so that brake mechanism lower contact member 60 may rotate around the longitudinal axis of outer shaft 68 along with a rotation of outer shaft 68.

In an embodiment each of the brake mechanism upper and lower contact members 58, 60 may be generally annular in shape and may include a plurality of fingers 108 extending radially outwardly. In an embodiment, plurality of fingers 108 may comprise eight fingers. In alternative embodiments, plurality of fingers 108 may comprise more or less than eight fingers. Function switch actuator 32 may be in sliding engagement with upper assembly outer housing 30 (FIG. 3) so that switch 32 may move generally linearly along a line generally parallel to the longitudinal axis of inner shaft 40. In an embodiment function switch actuator 32 may include an elongated member 154 which may have a predetermined length such that when function switch actuator 32 is in a first position, elongated member 154 may contact at least one of the plurality of fingers 108 of brake mechanism upper contact member 58 while not contacting any of the plurality of fingers 108 of brake mechanism lower contact member 60.

Similarly the length of elongated member 154 also may be such that when function switch actuator 32 is in a second position, elongated member 154 may contact at least one of the plurality of fingers 108 of brake mechanism lower contact member 60 while not contacting any of the plurality of fingers 108 of brake mechanism upper contact member 58. In an embodiment the length of elongated member 154 further may be such that during operation of jack and dolly assembly 10, elongated member 154 may contact either brake mechanism upper contact member 58 or brake mechanism lower contact member 60, and that there may be essentially no position of function switch actuator 32 where neither contact member is contacted at any particular point in time during operation, and essentially no position of function switch actuator 32 where both contact members 58, 60 are contacted simultaneously during operation.

In operation according to an embodiment, when function actuator switch 32 is in the first position while upper assembly gear mechanism 52 is receiving power, elongated member 154 may contact one of the plurality of fingers 108 of brake mechanism upper contact member 58 which in turn may prevent inner shaft 40 from rotating. Due to the predetermined length of elongated member 154 however, it may not contact any one of the plurality of fingers 108 of brake mechanism lower contact member 60 (when function actuator switch 32 is in the first position) and thus outer shaft 68 may rotate. On the other hand according to an embodiment, when function actuator switch 32 is in the second position while upper assembly gear mechanism 52 is receiving power, elongated member 154 may contact one of the plurality of fingers 108 of brake mechanism lower contact member 60 which in turn may prevent outer shaft 68 from rotating. Again however due to the predetermined length of elongated member 154, it may not contact any one of the plurality of fingers 108 of brake mechanism upper contact member 58 (when function actuator switch 32 is in the second position) and thus inner shaft 40 may rotate. According to an embodiment it can be seen that the brake assembly may be in a state of engagement or non-engagement with each of inner shaft 40 and outer shaft 68 to selectively interrupt the rotation of one of either of these two shafts during the time that the upper assembly gear mechanism 52 receives the input torque or driving force. However the other of these two shafts may rotate in response to the input torque or driving force.

In an embodiment, a brake mechanism may comprise a first contact member connected to an outer shaft, a second contact member connected to an inner shaft, and an actuator having a first position and a second position. When the actuator is in the first position, the actuator may come into contact with the first contact member and may not come into contact with the second contact member. When the actuator is in the second position, the actuator may come into contact with the second contact member and may not come into contact with the first contact member. In an embodiment, each of the first and second contact members is generally annular in shape and includes a plurality of fingers extending radially outwardly. The subject matter herein is not limited to the illustrated brake assembly. Embodiments may include structures that selectively prevent a relative movement between a member and either of two shafts. Such structures may include, but are not limited to: (a) magnetic brakes; (b) latches; (c) catches; (d) one or more shaft contact members having a generally annular shape and defining a plurality of detents, recesses, notches or grooves into which one or more members such as, for example, spring-loaded actuators, may mate; or (e) one or more shaft contact members, each having a generally polygonal shape comprising a plurality of edges, wherein a member or actuator may contact or abut each shaft contact member at a location proximate to said edges.

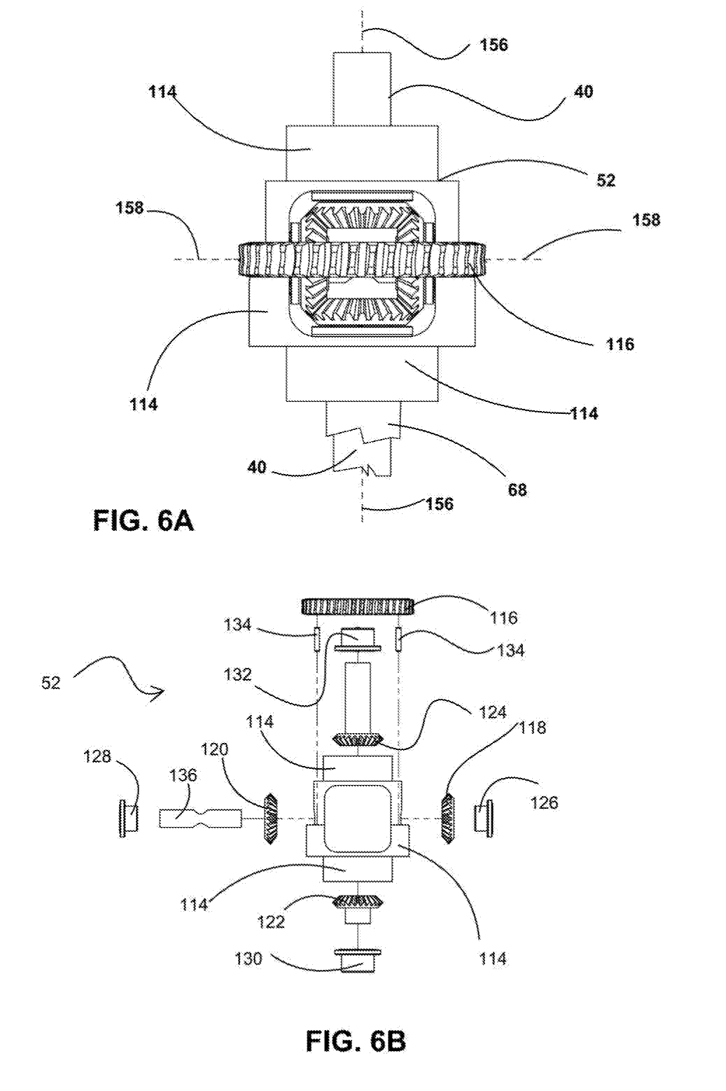

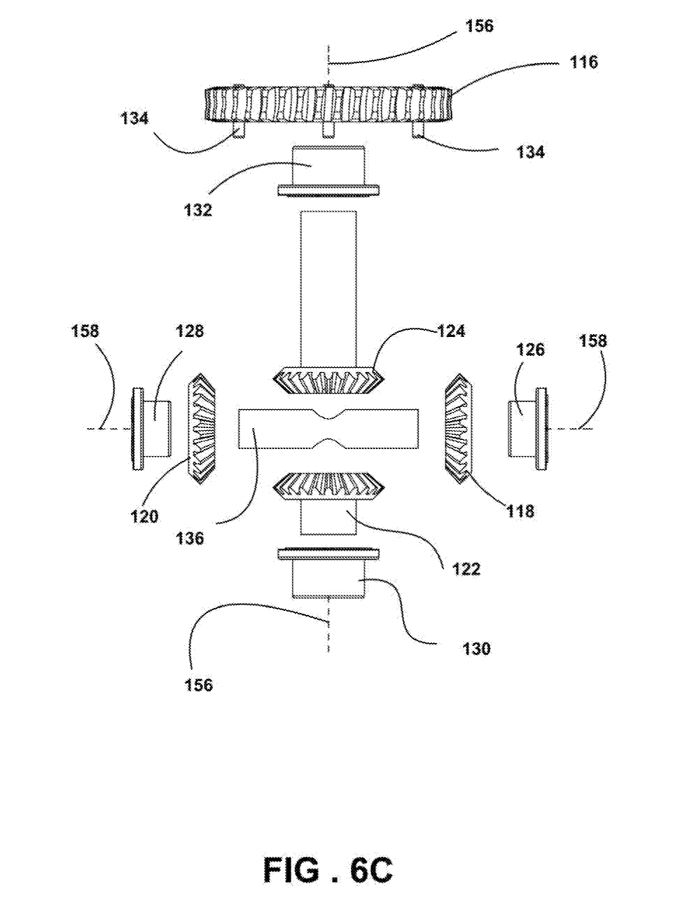

FIG. 6A is a plan view of upper assembly gear mechanism 52, a portion of inner shaft 40 and a portion of outer shaft 68. FIG. 6B is an exploded parts diagram of certain components of upper assembly gear mechanism 52. FIG. 6C is another exploded parts diagram of certain components of upper assembly gear mechanism 52, but with the components arranged in a different fashion and with first rotatable housing 114 of FIG. 6B removed for clarity of illustration. Referring to FIGS. 6A, 6B and 6C, upper assembly gear mechanism 52 may comprise first ring gear 116, first rotatable housing 114, first bevel gear 118, second bevel gear 120, third bevel gear 122, fourth bevel gear 124, first gear bearing 126, second gear bearing 128, third gear bearing 130, fourth gear bearing 132, mounting pins 134, and gear first shaft 136. As best seen in FIG. 6C, upon receipt of in input force such as, for example, a force received from power input handle 34 (FIG. 3) via worm gear 54 (FIG. 5), first ring gear 116 may rotate about ring gear axis 156. In the illustrated embodiment ring gear axis 156 may coincide with the longitudinal axis of inner shaft 40 and outer shaft 68. First ring gear 116 may be attached to first rotatable housing 114 (FIG. 6B) with mounting pins 134, and accordingly first rotatable housing 114 may also rotate around ring gear axis 156 in response to the rotation of first ring gear 116.

Gear first shaft 136 may be fixedly attached to first rotatable housing 114 (FIG. 6B) and may carry first bevel gear 118 at one end of the shaft and second bevel gear 120 at the opposite end of gear first shaft 136. First gear bearing 126 also may be attached to first rotatable housing 114 and gear first shaft 136 and may permit first bevel gear 118 to spin around gear first shaft 136 and around second axis 158. Accordingly first bevel gear 118 may be supported by gear first shaft 136 in a relatively rotatable manner with respect thereto. Second axis 158 in the illustrated embodiment may be generally perpendicular to ring gear axis 156, although alternative embodiments may comprise different orientations. Similarly second gear bearing 128 also may be attached to first rotatable housing 114 and gear first shaft 136 and may permit second bevel gear 120 to spin around gear first shaft 136 and second axis 158. Accordingly second bevel gear 120 may be supported by gear first shaft 136 in a relatively rotatable manner with respect thereto. In can be appreciated therefore that first and second bevel gears 118 and 120 may be movable in at least two dimensions. When first rotatable housing 114 (FIG. 6B) and gear first shaft 136 rotate around ring gear axis 156 (in response to first ring gear 116 rotation), first rotatable housing 114 and gear first shaft 136 may carry first and second bevel gears 118, 120, so that they also may move around ring gear axis 156. However because first and second bevel gears 118, 120 are also configured to spin around gear first shaft 136 and second axis 158, these gears may also move in this second dimension.

Third bevel gear 122 may be configured to spin around ring gear axis 156 and may be fixedly attached to outer shaft 68. Third gear bearing 130 also may be attached to outer shaft 68 and may permit first rotatable housing 114 to rotate around outer shaft 68 and third bevel gear 122 while rotating around ring gear axis 156. Because third bevel gear 122 may be connected to outer shaft 68 in a relatively non-rotatable manner with respect thereto, any spinning of third bevel gear 122 around ring gear axis 156 may cause outer shaft 68 also to rotate around ring gear axis 156. Similarly fourth gear bearing 132 may be configured to spin around ring gear axis 156 and may be attached to inner shaft 40 and permits first rotatable housing 114 to rotate around inner shaft 40 and fourth bevel gear 124 while rotating around ring gear axis 156. Because fourth bevel gear 124 may be fixedly attached to inner shaft 40 (e.g., connected to inner shaft 40 in a relatively non-rotatable manner with respect thereto), any spinning of fourth bevel gear 124 around ring gear axis 156 may cause inner shaft 40 to rotate around ring gear axis 156.

It can be appreciated therefore that first and second bevel gears 118, 120 may serve as driving gears, and third and fourth bevel gears 122, 124 may serve as driven gears, e.g., gears that are driven by or receive torque from first and second bevel gears 118, 120. A driving force may travel from power input handle 34 (FIG. 3) to worm gear 54 (FIG. 5) and then to first ring gear 116 and first rotatable housing 114 and then to first and second bevel gears 118, 120. As best seen in FIGS. 6A and 6C, first and second bevel gears 118, 120 may mesh or engage with third and fourth bevel gears 122, 124, so that as first and second bevel gears 118, 120 are carried around ring gear axis 156 by first rotatable housing 114, third and fourth bevel gears 122, 124 may be driven and caused to spin or rotate around ring gear axis 156 as well. Accordingly first and second bevel gears 118, 120 may comprise driving gears which drive the driven gears—third and fourth bevel gears 122, 124—and may cause them to spin.

If hypothetically both third and fourth bevel gears 122, 124 have no external force or resistance imposed upon them by, for example, a lack of external force or resistance placed upon outer and inner shafts 68, 40, respectively, then first and second bevel gears 118, 120 may not spin around second axis 158 as they are being carried around ring gear axis 156 by first rotatable housing 114. Also if hypothetically third and fourth bevel gears 122, 124 have an equal amount of external force or resistance imposed upon them, then first and second bevel gears 118, 120 likewise may not spin around second axis 158 as they are being carried around ring gear axis 156 and imparting force on third and fourth bevel gears 122, 124. The foregoing may be hypothetical however and may not be applicable to the embodiment of FIG. 5, in view of the operation of the brake assembly as discussed elsewhere herein.

However should more resistance be applied to third bevel gear 122, for example, as compared to resistance, if any, being applied to fourth bevel gear 124, then this differential in resistance may cause first and second bevel gears 118, 120 to spin around second axis 158 while they are being carried around ring gear axis 156 by first rotatable housing 114 and imparting force. Therefore if outer shaft 68 is prevented from rotating by brake mechanism lower contact member 60 and function switch actuator switch 32 (FIG. 5) as described elsewhere herein, then first and second bevel gears 118, 120 may be forced to spin around second axis 158 in order to accommodate the differential in resistance to rotation being experienced by third and fourth bevel gears 122, 124. Nevertheless first rotatable housing 114 may continue to move first and second bevel gears 118, 120 around ring gear axis 156 (while they also spin around second axis 158) thereby driving or rotating fourth bevel gear 124 (and inner shaft 40) notwithstanding that third bevel gear 122 (and outer shaft 68) may not be rotating.

A similar effect results when inner shaft 40 may be prevented from rotating by brake mechanism upper contact member 58 and function switch actuator switch 32 (FIG. 5) as described elsewhere herein. When this occurs, then first and second bevel gears 118, 120 again may be forced to spin around second axis 158 in order to accommodate the differential in resistance to rotation being experienced by third and fourth bevel gears 122, 124. Nevertheless first rotatable housing 114 may continue to carry first and second bevel gears 118, 120 around ring gear axis 156 (while they also may spin around second axis 158) thereby driving or rotating third bevel gear 122 (and outer shaft 68) notwithstanding that fourth bevel gear 124 (and inner shaft 40) may not be rotating.

In an embodiment upper assembly gear mechanism 52 may comprise a differential gear assembly configured to receive a driving force and generate at least two outputs. Inner shaft 40 may be coupled to a first one of the at least two outputs for rotation of inner shaft 40. Outer shaft 68 may be coupled to a second one of the at least two outputs for rotation of the outer shaft 68. Upper assembly gear mechanism 52 may be further configured to rotate inner shaft 40 during a time that external resistance is applied to outer shaft 68 and to rotate outer shaft 68 during a time that external resistance is applied to inner shaft 40.

While the upper assembly gear mechanism 52 of the illustrated embodiments may comprise first, second, third and fourth bevel gears 118, 120, 122, 124, alternative embodiments may include a gear mechanism having gears other than or in combination with bevel gears such as, for example, spur gears, helical gears, face gears, worm gears, hypoid gears, or any combination thereof, as well as other types of gears. While the upper assembly gear mechanism 52 of the illustrated embodiments may comprise two driving gears, e.g., first and second bevel gears 118, 120, alternative embodiments may include a gear mechanism having only one driving gear, or alternatively a gear mechanism having three or more driving gears. In an embodiment, a gear mechanism may comprise a housing configured for rotation about a rotational axis of the housing in response to a driving force. This mechanism may further comprise a gear shaft intersecting the rotational axis of the housing and being fixed thereto, and at least one gear rotatably supported upon the gear shaft. A pair of side gears may be engaged with the at least one gear at both sides thereof for transmitting the driving force to a first shaft or a second shaft.

In an embodiment, a jack and dolly assembly may comprise at least one wheel, a first shaft, a second shaft, and a brake mechanism having a first state and a second state. The first state may be one of engagement with the first shaft and non-engagement with the second shaft. The second state may be one of engagement with the second shaft and non-engagement with the first shaft. The jack and dolly assembly may further comprise means for rotating the first shaft during a time that the second shaft is not rotating and that the brake mechanism is in the first state, and for rotating the second shaft during a time that the first shaft is not rotating and that the brake mechanism is in the second state. The jack and dolly assembly may further comprise means for extending and retracting the at least one wheel in response to the rotation of the first shaft. The jack and dolly assembly may further comprise means for rotating the at least one wheel in response to the rotation of the second shaft.

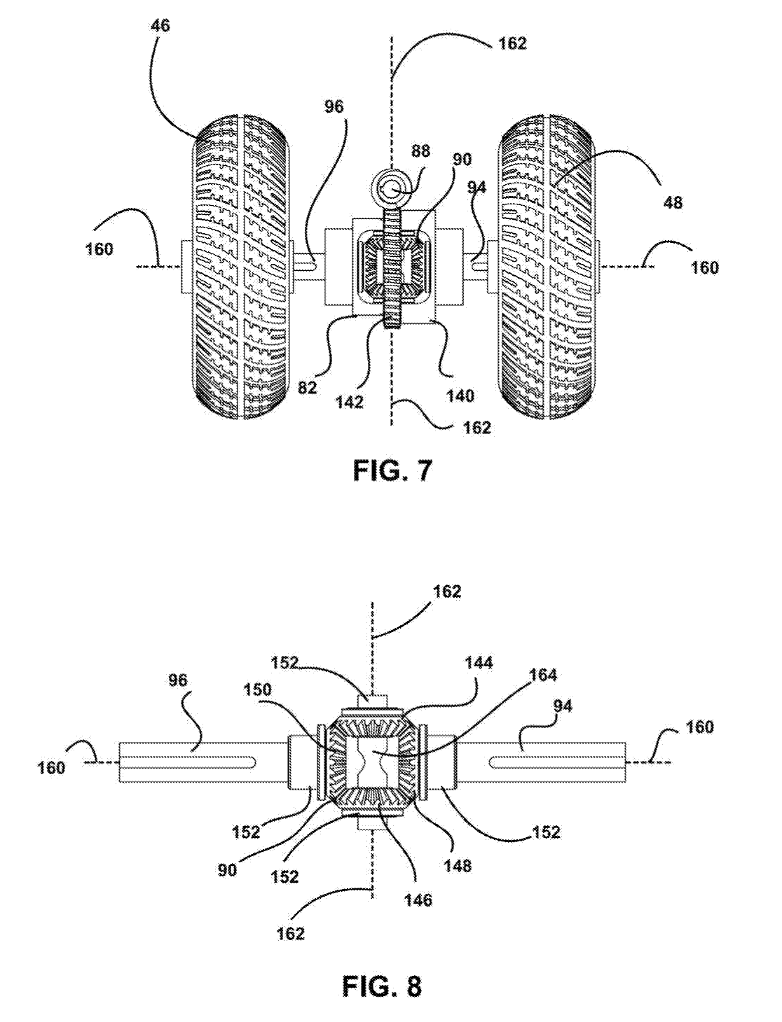

Referring now to FIG. 7, there are shown selected components of lower assembly portion 14 (FIGS. 4A and 4B) as an illustration of how first and second wheels 46, 48 may be driven or rotated according to an embodiment. For clarity of illustration lower assembly housing 44 (FIG. 4B) is not shown in FIG. 7. Components illustrated in FIG. 7 may include first and second wheels 46, 48, first wheel axle 96, second wheel axle 94, torque transfer gear 88, and lower assembly gear mechanism 82 which in turn comprises second ring gear 142, second rotatable housing 140 and plurality of gears 90. Inner shaft 40 (FIG. 4A) may be operatively coupled with torque transfer gear 88, which in turn may engage and rotate second ring gear 142 in a clockwise or a counterclockwise direction when inner shaft 40 is rotating. Second ring gear 142 may rotate around wheel axis 160 and may be attached to second rotatable housing 140 thus causing it to also rotate around wheel axis 160 in a clockwise or a counterclockwise direction. Lower assembly gear mechanism 82 therefore may drive first and second wheel axles 96, 94 by rotating them around wheel axis 160, which in turn may power first and second wheels 46, 48 so that they also may rotate around wheel axis 160 in a clockwise or a counterclockwise direction. Jack and dolly assembly 10 therefore may be moved generally axially and in a direction of fourth axis 162, for example, when first and second wheels 46, 48 are in contact with the ground or other surface and bearing some load.

FIG. 8 is a drawing of certain of the components of FIG. 7 and illustrates the operation of lower assembly gear mechanism 82 of FIG. 7. For clarity of illustration second rotatable housing 140 and second ring gear 142 are not shown in FIG. 8. Plurality of gears 90 may comprise fifth bevel gear 144, sixth bevel gear 146, seventh bevel gear 148 and eighth bevel gear 150. Fifth bevel gear 144 and sixth bevel gear 146 may be mounted on opposite ends of gear second shaft 164 along with bearings 152 associated with each bevel gear. Gear second shaft 164 may be connected to second rotatable housing 140, so that gear second shaft 164, as well as fifth and sixth bevel gears 144, 146, all may be carried around wheel axis 160 by second rotatable housing 140. Fifth and sixth bevel gears 144, 146 may mesh or engage with seventh bevel gear 148 and eighth bevel gear 150. Accordingly as fifth and sixth bevel gears 144, 146 are carried around wheel axis 160, they may drive seventh and eighth bevel gears 148, 150 thus causing them to spin or rotate around wheel axis 160, assisted by bearings 152 associated with each gear.

Seventh and eighth bevel gears 148, 150 may be fixedly attached to second and first wheel axles 94, 96, respectively, and accordingly may drive second and first wheel axles 96, 94 by causing them to rotate in a clockwise or counterclockwise direction around wheel axis 160. During a time that seventh and eighth bevel gears 148, 150 may experience the same amount of friction or resistance via second and first wheel axles 96, 94 and via second and first wheels 46, 48, then fifth and sixth bevel gears 144, 146 may not spin around fourth axis 162 as they are carried around wheel axis 160 and as they drive seventh and eighth bevel gears 148, 150. However should either one of seventh and eighth bevel gears 148, 150 experience more resistance than the other bevel gear, then fifth and sixth bevel gears 144, 146 may spin or rotate around fourth axis 162 assisted by bearings 152 in order to accommodate this differential resistance while at the same time driving seventh and/or eighth bevel gears 148, 150. While the plurality of lower assembly gears 90 of the illustrated embodiment may comprise fifth, sixth, seventh, and eighth bevel gears 144, 146, 148, 150, alternative embodiments may include a plurality of lower assembly gears comprising gears other than or in combination with bevel gears such as, for example, spur gears, helical gears, face gears, worm gears, hypoid gears, or any combination thereof, as well as other types of gears.

In an embodiment, a wheel assembly may include lower assembly gear mechanism which in turn may comprise a differential gear for transferring torque of a shaft to at least one wheel. In an embodiment, a jack and dolly assembly may include a wheel assembly which may comprise at least one axle and a differential gear assembly for transferring torque of a shaft to the at least one axle. In an embodiment a wheel assembly may comprise at least one axle; and one or more of a worm gear, a crown gear, a helical gear, a chain and sprocket assembly, a universal joint, or any combination thereof, for transferring torque of a shaft to the at least one axle.

According to an embodiment, a method for operating a jack and dolly assembly is provided whereby a brake mechanism of the jack and dolly assembly may be placed in a first state, which may be one of engagement with a first shaft to prevent rotation of the first shaft and non-engagement with a second shaft. At least one wheel of the jack and dolly assembly may be extended or retracted by operating a driving unit to rotate the second shaft during a time that the brake mechanism is in the first state and that the first shaft is not rotating. The brake mechanism may be placed in a second state, which may be one of engagement with the second shaft to prevent rotation of the second shaft and non-engagement with the first shaft. The at least one wheel of the jack and dolly assembly may be rotated by operating the driving unit to rotate the first shaft during a time that the brake mechanism is in the second state and that the second shaft is not rotating.

In an embodiment of the foregoing method, one of the first shaft and the second shaft may comprise an outer shaft defining a longitudinal axis extending through the outer shaft and further defining an interior hollow extending along the longitudinal axis. The other shaft of the first and second shafts may comprise an inner shaft at least partially positioned longitudinally within the interior hollow of the outer shaft.

In an embodiment, the operating of the driving unit to rotate the first shaft may include providing a driving force to a gear assembly operatively coupled to the first shaft, and the operating of the driving unit to rotate the second shaft may include providing the driving force to the gear assembly operatively coupled to the second shaft. The gear assembly may comprise a housing, a gear shaft, at least one gear, and a pair of side gears. The housing may be configured for rotation about a rotational axis of the housing in response to the driving force. The gear shaft may intersect the rotational axis of the housing and be fixed thereto. The at least one gear may be rotatably supported upon the gear shaft. The pair of side gears may be engaged with the at least one gear at both sides thereof for transmitting the driving force to the first shaft or the second shaft.

Certain illustrated embodiments described elsewhere herein may include a jack and dolly assembly having an outer shaft that includes threads for engagement with a threaded member, or nut, for use in providing a generally linear force, such as lifting or lowering for example. However alternative embodiments may include an inner shaft that includes threads for engagement with a threaded member, or nut, for use in providing a generally linear force, such as lifting or lowering, for example, and may further include an outer shaft for use in transmitting torque for rotating one or more wheels.

Certain illustrated embodiments described elsewhere herein may include a jack and dolly assembly having an outer shaft as well as an inner shaft, at least a portion of which may be disposed longitudinally within the outer shaft. However alternative embodiments may not include nested shafts. That is, embodiments may include a first shaft for use in providing a generally linear force, such as lifting or lowering for example, and a second shaft for use in providing torque for rotating one or more wheels, wherein neither the first nor second shaft is partially or wholly disposed within the other.

Moreover certain illustrated embodiments described elsewhere herein may include a jack and dolly assembly wherein a gear assembly (that transfers torque to rotate the two shafts) may be disposed at an upper end of the jack and dolly assembly and wherein both shafts transfer torque to components disposed below the gear assembly. However alternative embodiments may include a jack and dolly assembly wherein the gear assembly that transfers torque to rotate the two shafts (for providing a generally linear force and for rotating at least one wheel), is disposed at a lower end of the jack and dolly assembly. In such an embodiment, one shaft may transfer torque to one or more components above the gear assembly for providing the generally linear force. The other shaft may transfer torque to one or components for rotating one or more wheels, wherein the other shaft may be disposed at or near an elevation of the gear assembly.

The particular combinations of elements and features in the embodiments described herein are exemplary only; the interchanging and substitution of these teachings with other teachings in this and the incorporated-by-reference documents are also expressly contemplated and intended.

Terms such as “over”, “under”, “above” and “below” may be used to facilitate discussion, but are not intended to necessarily restrict scope of claimed subject matter. For example, the terms “over” and “above”, as an example, are not meant to suggest that claim scope is limited to only situations in which an embodiment is right side up, such as in comparison with the embodiment being upside down, for example. An example includes an apparatus or assembly, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent document, particular context of description and/or usage provides helpful guidance regarding reasonable inferences to be drawn.

Unless otherwise indicated, in the context of the present patent document the term “or” if used to associate a list, such as A, B, or C, is intended to mean A, B, and C, here used in the inclusive sense, as well as A, B, or C, here used in the exclusive sense. The term “and/or” can be used in an abundance of caution to make clear that all of the foregoing meanings are intended, although such usage is not required. In addition, the term “one or more” and/or similar terms is used to describe any feature, structure, characteristic, and/or the like in the singular. The term “and/or” is also used to describe a plurality and/or some other combination of features, structures, characteristics, and/or the like.

Unless expressly stated otherwise, the term “coupled” as used herein is a broad term and is to be given its ordinary and customary meaning to a person of ordinary skill in the art (and is not to be limited to a special or customized meaning), and furthermore refers without limitation to both an indirect attachment between two or more parts while nonetheless being able to co-operate or interact, as well as a direct contact between two or more parts. Unless expressly stated otherwise, the terms “connected” and “attached” as used herein are broad terms and are to be given its ordinary and customary meaning to a person of ordinary skill in the art (and is not to be limited to a special or customized meaning), and furthermore refers without limitation to both an indirect attachment between two or more parts, as well as a direct attachment between two or more parts.

It is appreciated that throughout this document the use of terms such as “first”, “second”, “third”, etc., is a common patent-language convention to distinguish between repeated instances of an element or limitation. Unless the context clearly indicates otherwise, these terms are to distinguish different elements of an embodiment or claim, and are not terms intended to supply a numerical limit, and are not terms to indicate that elements, limitations or actions must appear or be performed in that order.

References throughout this specification to “one implementation”, “an implementation”, “one embodiment”, “an embodiment” and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

In view of the above, it will be appreciated that certain embodiments may overcome many of the long-standing problems in the art by providing a combined jack and dolly assembly that may both lift or otherwise move an object in a generally linear direction, as well as travel or move on a generally horizontal surface, using a single power source. Advantageously this can reduce the size and manufacturing costs of the jack and dolly assembly. In some embodiments a first shaft may be used for a lifting or other generally linear movement, and a second shaft may be used for moving on a generally horizontal surface. In some embodiments the first and second shafts may selectively move or rotate independently from one another while being powered by a single power source. In some embodiments an inner and outer shaft arrangement is provided, so that the outer shaft may have a hollow, generally longitudinal interior, and at least a portion of the inner shaft may be positioned longitudinally within the hollow interior. Advantageously this may save space and reduce the overall size of the jack and dolly assembly.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A jack and dolly assembly comprising:
a driving unit and at least one wheel;
a differential gear assembly configured to receive a driving force from the driving unit and to generate at least two outputs;
a first shaft coupled to a first one of the at least two outputs for rotation of the first shaft;
a second shaft coupled to a second one of the at least two outputs for rotation of the second shaft,
wherein the differential gear assembly is further configured to rotate the first shaft during a time that external resistance is applied to the second shaft and to rotate the second shaft during a time that external resistance is applied to the first shaft; and
a brake mechanism having a state of engagement or non-engagement with each of the first shaft and the second shaft to selectively interrupt the rotation of one of the first and second shafts during the time that the differential gear assembly is receiving the driving force,
wherein the one of the first and second shafts comprises a lead screw for use in translating rotation of the lead screw into a generally linear motion for extending or retracting the at least one wheel, and wherein the other of the first and second shafts comprises at least a portion of a drive train for rotating the at least one wheel.

2. The jack and dolly assembly of claim 1, wherein the brake mechanism comprises a first contact member connected to the first shaft, a second contact member connected to the second shaft, and an actuator having a first position and a second position,
wherein when the actuator is in the first position, the actuator comes into contact with the first contact member and does not come into contact with the second contact member, and
wherein when the actuator is in the second position, the actuator comes into contact with the second contact member and does not come into contact with the first contact member.

3. The jack and dolly assembly of claim 2, wherein each of the first and second contact members is generally annular in shape and includes a plurality of fingers extending radially outwardly, and wherein the actuator is configured to engage at least one of the plurality of fingers of the first contact member when the actuator is in the first position and to engage at least one of the plurality of fingers of the second contact member when the actuator is in the second position.

4. A jack and dolly assembly comprising:
an outer shaft defining a longitudinal axis extending through the outer shaft and further defining an interior hollow extending along the longitudinal axis;
an inner shaft at least partially positioned within the interior hollow of the outer shaft;
a gear assembly operatively coupled to the outer and inner shafts to rotate the outer shaft in response to a driving force received by the gear assembly during a time that external resistance is applied to the inner shaft, and to rotate the inner shaft in response to the driving force received by the gear assembly during a time that external resistance is applied to the outer shaft;
a brake mechanism having a state of engagement or non-engagement with each of the outer shaft and the inner shaft to selectively interrupt the rotation of one of the inner and outer shafts while not interrupting the rotation of the other of the inner and outer shafts during a time that the gear assembly is receiving the driving force;
a wheel assembly comprising at least one wheel, wherein the at least one wheel is rotatively coupled to a first one of the inner shaft and the outer shaft;
a threaded member engaged with a second one of the inner shaft and the outer shaft,
wherein the first one of the inner shaft and the outer shaft is coupled to the at least one wheel to impart a driving rotation to the at least one wheel in response to the rotation of the first one of the inner shaft and the outer shaft;
wherein the second one of the inner shaft and the outer shaft has threads which engage the threaded member; and
wherein the wheel assembly is coupled with the threaded member so that rotation of the second one of the inner shaft and the outer shaft causes a generally linear translation of the wheel assembly.

5. The jack and dolly assembly of claim 4, wherein the second one of the inner shaft and the outer shaft comprises a lead screw and wherein the threaded member comprises a lead nut.

6. The jack and dolly assembly of claim 4, wherein the gear assembly comprises:
a housing configured for rotation about a rotational axis of the housing in response to the driving force;
a gear shaft intersecting the rotational axis of the housing and being fixed thereto;
at least one gear rotatably supported upon the gear shaft; and
a pair of side gears engaged with the at least one gear at both sides thereof for transmitting the driving force to the inner shaft or the outer shaft.

7. The jack and dolly assembly of claim 6, wherein the at least one gear comprises a bevel gear or a pinion gear, and wherein the pair of side gears comprise a pair of bevel gears or a pair of pinion gears.

8. The jack and dolly assembly of claim 4, wherein the brake mechanism comprises a first contact member connected to the outer shaft, a second contact member connected to the inner shaft, and an actuator having a first position and a second position,
wherein when the actuator is in the first position, the actuator comes into contact with the first contact member and does not come into contact with the second contact member, and
wherein when the actuator is in the second position, the actuator comes into contact with the second contact member and does not come into contact with the first contact member.

9. The jack and dolly assembly of claim 8, wherein each of the first and second contact members is generally annular in shape and includes a plurality of fingers extending radially outwardly.

10. The jack and dolly assembly of claim 4, wherein the wheel assembly further comprises a differential gear assembly and at least one axle, and wherein the at least one wheel is rotatively coupled to the first one of the inner shaft and the outer shaft via the differential gear assembly and the at least one axle.

11. The jack and dolly assembly of claim 4, wherein the wheel assembly further comprises:
at least one axle; and
one or more of a worm gear, a crown gear, a helical gear, a chain and sprocket assembly, a universal joint, or any combination thereof,
wherein the at least one wheel is rotatively coupled to the first one of the inner shaft and the outer shaft via the at least one axle and via the one or more of a worm gear, a crown gear, a helical gear, a chain and sprocket assembly, a universal joint, or any combination thereof.

12. The jack and dolly assembly of claim 4, further comprising a driving unit operatively coupled to the gear assembly to provide the driving force.

13. The jack and dolly assembly of claim 12, wherein the driving unit comprises one of a hand crank and an electric motor.

14. The jack and dolly assembly of claim 12, wherein the gear assembly comprises:
a ring gear operatively coupled to the driving unit;
first and second gears connected to the inner and outer shafts, respectively, in a relatively non-rotatable manner with respect thereto;
a gear shaft operatively coupled to the ring gear to rotate together with the ring gear; and
a third gear engaged with the first and second gears and supported by the gear shaft in a relatively rotatable manner with respect thereto.

15. The jack and dolly assembly of claim 14, wherein the gear assembly further comprises a fourth gear engaged with the first and second gears and operatively coupled to the ring gear to rotate together with the ring gear.

16. The jack and dolly assembly of claim 14, wherein each of the first, second and third gears comprises a bevel gear or a pinion gear.

17. A jack and dolly assembly comprising:
an outer shaft defining a longitudinal axis extending through the outer shaft and further defining an interior hollow extending along the longitudinal axis;
an inner shaft at least partially positioned longitudinally within the interior hollow of the outer shaft;
a driving unit;
a ring gear having a ring gear axis and coupled to the driving unit, wherein the ring gear is configured to rotate about the ring gear axis in response to a driving force from the driving unit;
a driving gear coupled to the ring gear and having a driving gear axis substantially transverse to the ring gear axis,
wherein the driving gear is configured to rotate around the driving gear axis, and
wherein the driving gear is further configured to be carried around the ring gear axis in response to a rotation of the ring gear;
a first driven gear and a second driven gear,
wherein each of the first and second driven gears is engaged with the driving gear and is configured to rotate about the ring gear axis in response to movement of the driving gear around the ring gear axis,
wherein the first driven gear is connected to the outer shaft and configured to rotate the outer shaft, and
wherein the second driven gear is connected to the inner shaft and configured to rotate the inner shaft;
a brake mechanism having a first brake position and a second brake position,
wherein during a time that the brake mechanism is in the first brake position, the brake mechanism is configured to prevent rotation of the first driven gear and the outer shaft while the second driven gear and the inner shaft are rotating in response to the rotation of the driving gear and,
wherein during a time that the brake mechanism is in the second brake position, the brake mechanism is configured to prevent rotation of the second driven gear and the inner shaft while the first driven gear and the outer shaft are rotating in response to the rotation of the driving gear; and
a wheel assembly comprising at least one wheel, wherein the wheel assembly is threadedly coupled to one of the outer shaft and the inner shaft, and wherein the at least one wheel is rotatively coupled to the other one of the outer shaft and the inner shaft,
wherein the wheel assembly is configured to move in a generally linear direction along or parallel to the longitudinal axis of the outer shaft in response to the rotation of the one of the outer and inner shafts, and
wherein the at least one wheel is configured to rotate in response to the rotation of the other one of the outer and inner shafts.

18. The jack and dolly assembly of claim 17 further comprising a threaded member coupled to the wheel assembly,
wherein the outer shaft includes threads and is threadedly engaged with the threaded member,
wherein the wheel assembly is configured to move in the generally linear direction in response to the rotation of the outer shaft, and
wherein the at least one wheel is configured to rotate in response to the rotation of the inner shaft.

19. A jack and dolly assembly comprising:
at least one wheel;
a first shaft and a second shaft;
a brake mechanism having a first state and a second state,
wherein the first state is one of engagement with the first shaft and non-engagement with the second shaft, and
wherein the second state is one of engagement with the second shaft and non-engagement with the first shaft;
means for rotating the first shaft during a time that the second shaft is not rotating and that the brake mechanism is in the first state, and for rotating the second shaft during a time that the first shaft is not rotating and that the brake mechanism is in the second state;
means for extending and retracting the at least one wheel in response to the rotation of the first shaft; and
means for rotating the at least one wheel in response to the rotation of the second shaft.

20. A method for operating a jack and dolly assembly, the method comprising:
placing a brake mechanism of the jack and dolly assembly in a first state, wherein the first state is one of engagement with a first shaft to prevent rotation of the first shaft and non-engagement with a second shaft;
extending or retracting at least one wheel of the jack and dolly assembly by operating a driving unit to rotate the second shaft during a time that the brake mechanism is in the first state and that the first shaft is not rotating;
placing the brake mechanism in a second state, wherein the second state is one of engagement with the second shaft to prevent rotation of the second shaft and non-engagement with the first shaft; and
rotating the at least one wheel of the jack and dolly assembly by operating the driving unit to rotate the first shaft during a time that the brake mechanism is in the second state and that the second shaft is not rotating.

21. The method of claim 20 wherein one of the first shaft and the second shaft comprises an outer shaft defining a longitudinal axis extending through the outer shaft and further defining an interior hollow extending along the longitudinal axis, and wherein the other shaft of the first and second shafts comprises an inner shaft at least partially positioned within the interior hollow of the outer shaft.

22. The method of claim 20 wherein the operating of the driving unit to rotate the first shaft includes providing a driving force to a gear assembly operatively coupled to the first shaft, wherein the operating of the driving unit to rotate the second shaft includes providing the driving force to the gear assembly operatively coupled to the second shaft, wherein the gear assembly comprises:
a housing configured for rotation about a rotational axis of the housing in response to the driving force;
a gear shaft intersecting the rotational axis of the housing and being fixed thereto;
at least one gear rotatably supported upon the gear shaft; and
a pair of side gears engaged with the at least one gear at both sides thereof for transmitting the driving force to the first shaft or the second shaft.
